(19) United States
(12) Patent Application Publication
(10) Pub. No.: US 2021/0144295 A1
(43) Pub. Date: May 13, 2021

(54) PHOTOGRAPHING PROCESSING METHOD, DEVICE AND STORAGE MEDIUM

(71) Applicant: SZ DJI TECHNOLOGY CO., LTD., Shenzhen (CN)

(72) Inventors: Guotao MENG, Shenzhen (CN); Xuyang FENG, Shenzhen (CN)

(21) Appl. No.: 17/154,875

(22) Filed: Jan. 21, 2021

Related U.S. Application Data
(63) Continuation of application No. PCT/CN2018/097805, filed on Jul. 31, 2018.

(51) Int. Cl. H04N 5/232; G06T 7/00

(52) U.S. Cl. CPC H04N 5/23216; G06T 2207/20021; G06T 2207/30168; G06T 7/0002

(57) ABSTRACT

A photographing processing method includes receiving an image of a target object photographed by a photographing device, obtaining a key point of the image, determining whether clarity information of the key point satisfies a clarity condition, and adjusting a photographing parameter of the photographing device in response to the clarity information of the key point not satisfying the clarity condition.

### CROSS-REFERENCE TO RELATED APPLICATION

This application is a continuation of International Application No. PCT/CN2018/097805, filed on Jul. 31, 2018, the entire content of which is incorporated herein by reference.

### TECHNICAL FIELD

The present disclosure relates to the technical field of controls and, more particularly, to a photographing processing method and device, and a storage medium.

### BACKGROUND

Currently, when photographing a target object such as people portraits or animals (e.g., a cat, a dog, etc.), a photographer primarily manually adjusts a photographing device to control the quality of images. However, the manual adjustment by the photographer often causes problems such as overly shallow depth of field, thereby resulting in unclear images.

Therefore, it is important to effectively control the photographing device to improve the quality the images.

### SUMMARY

In accordance with the disclosure, there is provided a photographing processing method. The method includes receiving an image of a target object photographed by a photographing device, obtaining a key point of the image, determining whether clarity information of the key point satisfies a clarity condition, and adjusting a photographing parameter of the photographing device in response to the clarity information of the key point not satisfying the clarity condition.

Also in accordance with the disclosure, there is provided a photographing processing device. The device includes a memory storing program instructions and a processor configured to execute the program instructions to receive an image of a target object photographed by a photographing device, obtain a key point of the image, determine whether clarity information of the key point satisfies a clarity condition, and adjust a photographing parameter of the photographing device in response to the clarity information of the key point not satisfying the clarity condition.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of a photographing processing system according to an example embodiment of the present disclosure.

FIG. 2 is a flow chart of a photographing processing method according to an example embodiment of the present disclosure.

FIG. 3A is a schematic diagram of an interface showing key points of an image according to an example embodiment of the present disclosure.

FIG. 3B is a schematic diagram of an interface showing key points of a target image region according to an example embodiment of the present disclosure.

FIG. 3C is a schematic diagram of an interface showing determination of the target image region according to an example embodiment of the present disclosure.

FIG. 4 is a flow chart of a photographing processing method according to another example embodiment of the present disclosure.

FIG. 5 is a flow chart of a photographing processing method according to another example embodiment of the present disclosure.

FIG. 6 is a flow chart of a photographing processing method according to another example embodiment of the present disclosure.

FIG. 7 is a structural diagram of a photographing processing device according to an example embodiment of the present disclosure.

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure. In addition, under circumstances of no conflict, the embodiments and the features in the embodiments may be combined with each other.

The present disclosure provides a photographing processing method. The method may be executed by a photographing processing device. The photographing processing device may be provided at a terminal device equipped with a photographing device. In some embodiments, the photographing processing device may be provided at the terminal device that communicates with the photographing device. In some embodiments, the photographing processing device may be provided at a movable robot equipped with the photographing device. In some embodiments, the photographing processing device may be physically separated from the movable robot. In some other embodiments, the photographing processing device may be a part of the movable robot. That is, the movable robot includes the photographing processing device. The movable robot may be a robot that can move, such as an unmanned aerial vehicle (UAV), an unmanned automobile, or an unmanned boat, etc. The photographing processing device and the movable robot communicate with each other bidirectionally.

In some embodiments, the photographing processing device may receive an image of a target object photographed by the photographing device. After the image is received, the photographing processing device obtains a key point of the image and determines whether clarity information of the key point satisfies a clarity condition. In response to the clarity information of the key point not satisfying the clarity condition, a photographing parameter of the photographing device may be adjusted. In response to the clarity information of the key point satisfying the clarity condition, the image is outputted. In the embodiments of the present disclosure, the photographing parameter of the photographing device is adjusted to improve clarity and quality of the image. For illustration purpose, the UAV is the example of the movable robot in the description below.

FIG. 1 is a schematic structural diagram of a photographing processing system according to an example embodiment of the present disclosure. As shown in FIG. 1, the photographing processing system includes a photographing processing device 11 and a UAV 12. The photographing processing device 11 and the UAV 12 communicate through a wireless connection. Under certain circumstances, the photographing processing device 11 and the UAV 12 may also communicate through a wired connection between the photographing processing device 11 and the UAV 12. The UAV 12 may be a rotary-wing aircraft, such as a quad-rotor aircraft, a hexa-rotor aircraft, an eight-rotor aircraft, or a fixed-wing aircraft. The UAV 12 includes a propulsion system 121 configured to drive the UAV 12 to fly.

The photographing processing method provided by the embodiments of the present disclosure will be described in detail below with reference to the accompanying drawings.

FIG. 2 is a flow chart of a photographing processing method according to an example embodiment of the present disclosure. The method may be executed by the above-described photographing processing device. As shown in FIG. 2, the photographing processing method includes the following processes.

At S201, an image of a target object photographed by a photographing device is received.

In some embodiments, the photographing processing device receives the image of the target object photographed by the photographing device. The target object may be a human, an animal, or a plant, etc. In some other embodiments, the image received by the photographing processing device may be a human face image, an animal face image, or an image of another part, which is not limited in the present disclosure.

At S202, a key point of the image is obtained.

In some embodiments, the photographing processing device may obtain the key point of the image based on the image of the target object photographed by the photographing device. In some embodiments, one or more key points may be obtained. For example, assuming that the image is the human face, the key points of the image may include the key points of eyebrows, eyes, nose, mouth, or another part of the human face.

FIG. 3A is a schematic diagram of an interface showing key points of an image according to an example embodiment of the present disclosure. As shown in FIG. 3A, the image includes a human face 31. The human face 31 includes key points 32. In some embodiments, the key points 32 of the image may be obtained by performing a calculation based on a pre-configured algorithm such as a deep learning algorithm. The present disclosure does not limit how to obtain the key points of the image.

In some embodiments, when the photographing processing device determines the key points of the image, the photographing processing device may determine position information of each key point relative to the image and a corresponding sequence number of each key point based on the pre-configured algorithm such as the deep learning algorithm.

For example, when the photographing processing device determines the key points of the image, the photographing processing device may determine the position information of a key point relative to the image to be coordinate information (u, v) and the corresponding sequence number of the key point returned by the pre-configured algorithm such as the deep learning algorithm.

At S203, whether clarity information of the key point satisfies a clarity condition is determined.

In some embodiments, the photographing processing device may determine whether the clarity information of the key point satisfies the clarity condition.

In some embodiments, the photographing processing device determines whether the clarity information of the key point satisfies the clarity condition by determining a response value of a clarity evaluation function for the key point. After the photographing processing device adjusts the photographing parameter, the photographing processing device determines whether the clarity information of the key point satisfies the clarity condition by detecting whether the response value of the clarity evaluation function for the key point changes.

At S204, in response to the clarity information of the key point not satisfying the clarity condition, the photographing parameter of the photographing device is adjusted.

In some embodiments, in response to the photographing processing device detecting that the clarity information of the key point does not satisfy the clarity condition, the photographing processing device adjusts the photographing parameter of the photographing device.

In some embodiments, after the photographing processing device obtains the key point of the image, the photographing processing device detects whether the clarity information of the key point satisfies the clarity condition. In response to detecting that the clarity information of the key point does not satisfy the clarity condition, the photographing processing device adjusts the photographing parameter of the photographing device until the clarity information of the key point in the image satisfies the clarity condition. After it is detected that the clarity information of all the key points in the image satisfies the clarity condition, the photographing processing device outputs the image.

In some embodiments, the photographing parameter includes at one of aperture, shutter speed, or sensitivity, etc. in some embodiments, the evaluation function includes a clarity evaluation function and a brightness evaluation function. In some other embodiments, the evaluation function may also include another type of the evaluation function, which is not limited in the present disclosure.

In some embodiments, the evaluation function includes the clarity evaluation function. The clarity information not satisfying the clarity condition may refer to that after the photographing parameter of the photographing device is adjusted, the response value of the clarity evaluation function for one or more key points changes.

For example, assuming that the photographing parameter is the aperture. After the aperture of the photographing device is adjusted, the response value of the clarity evaluation function for one or more key points increases relative to the response value of the clarity evaluation function before the aperture of the photographing device is adjusted. Then, it is determined that the clarity information of the key point in the image does not satisfy the clarity condition.

In some embodiments, the photographing processing device receives the image of the target object photographed by the photographing device, obtains the key point of the image, and detects whether the clarity information of the key point in the image satisfies the clarity condition. In response to the clarity information of the key point not satisfying the clarity condition, the photographing processing device adjust the photographing parameter of the photographing device. Through adjusting the photographing parameter of the photographing device, the photographing device may photograph the image more effectively, thereby improving the quality of the image.

FIG. 4 is a flow chart of a photographing processing method according to another example embodiment of the present disclosure. The method may be executed by the above-described photographing processing device. The method shown in FIG. 4 is similar to the method shown in FIG. 2. The difference is a detail description of obtaining the key point of the image shown in FIG. 4. As shown in FIG. 4, the method includes the following processes.

At S401, an image of a target object photographed by a photographing device is received.

In some embodiments, the photographing processing device may receive the image of the target object photographed by the photographing device. The previous description can be referred to for the specific implementation, which will not be repeated herein.

At S402, a target image region in the image is determined.

In some embodiments, the photographing processing device may determine the target image region in the image. In some embodiments, the target image region may be a partial region in the image, such as an image region showing eyebrows, eyes, nose, mouth, and the like.

FIG. 3B is a schematic diagram of an interface showing key points of a target image region according to an example embodiment of the present disclosure. As shown in FIG. 3B, the image is a human face image 31. The photographing processing device may determine an image region 311 showing the right eye to be the target image region of the image.

In some embodiments, the photographing processing device may determine the target image region of the image by an image region selection operation. In some embodiments, the image region selection operation may be an operation executed by a user at the photographing processing device or an operation executed by the user at the photographing device. In some embodiments, the image region selection operation executed by the user at the photographing processing device may be at least one of a single-click operation, a double-click operation, a sliding operation, or a frame selection operation. In some other embodiments, the image region selection operation executed by the user at the photographing processing device may be at least one of a button-click operation, a lens rotation operation, or the like.

FIG. 3C is a schematic diagram of an interface showing determination of the target image region according to an example embodiment of the present disclosure. As shown in FIG. 3C, assuming that the image region selection operation is the frame selection operation 33, in response to the frame selection operation 33, the photographing processing device may determine the target image region 331 selected by the frame selection operation 33.

At S403, a key point of the target image region is obtained.

In some embodiments, the photographing processing device may obtain the key point of the target image region. For example, as shown in FIG. 3C, after the photographing processing device determines the target image region 331, the photographing processing device may determine one or more of key points of the target image region 331.

At S404, whether clarity information of the key point satisfies a clarity condition is determined.

In some embodiments, the photographing processing device may determine whether the clarity information of the key point satisfies the clarity condition. The previous description can be referred to for the specific implementation, which will not be repeated herein.

At S405, in response to the clarity information of the key point of the target image region not satisfying the clarity condition, a photographing parameter of the photographing device is adjusted.

In some embodiments, in response to the clarity information of the key point of the target image region not satisfying the clarity condition, the photographing processing device may adjust the photographing parameter of the photographing device. The previous description can be referred to for the specific implementation, which will not be repeated herein.

In some embodiments, the photographing processing device receives the image of the target object photographed by the photographing device, determines the target image region in the image by the image region selection operation, and obtains the key point of the target image region. In response to the clarity information of the key point of the target image region not satisfying the clarity condition, the photographing processing device adjusts the photographing parameter of the photographing device. In this way, the clarity of the key point of the target image region in the image is adjusted, and the efficiency of adjusting the clarity of the key point is improved.

FIG. 5 is a flow chart of a photographing processing method according to another example embodiment of the present disclosure. The method may be executed by the above-described photographing processing device. The method shown in FIG. 5 is similar to the method shown in FIG. 4. The difference is a detail description of adjusting the aperture of the photographing device according to the clarity evaluation function. As shown in FIG. 5, the method includes the following processes.

At S501, an image of a target object photographed by a photographing device is received.

In some embodiments, the photographing processing device may receive the image of the target object photographed by the photographing device. The previous description can be referred to for the specific implementation, which will not be repeated herein.

At S502, a key point of the image is obtained.

In some embodiments, the photographing processing device may obtain the key point of the image. The previous description can be referred to for the specific implementation, which will not be repeated herein.

At S503, a response value of a clarity evaluation function for the key point is determined.

In some embodiments, the photographing processing device may determine the response value of the clarity evaluation function for the key point. In some embodiments, the photographing parameter of the photographing device includes the aperture. In some embodiments, the response value of the clarity evaluation function for the key point increases as the aperture decreases.

In some embodiments, after the photographing processing device obtains the key point of the image, the photographing processing device determines position of the key point relative to the image, such as a coordinate (u, v) of the obtain the key point of the image. According to the position of the key point relative to the image, the photographing processing device determined the response value of the clarity evaluation function for the key point.

At S504, whether the response value of the clarity evaluation function changes after the aperture of the photographing device is adjusted is detected. In response to detecting that the response value of the clarity evaluation function changes (S504: Yes), S505 is executed. Otherwise (S504: No), S508 is executed.

In some embodiments, the photographing processing device may adjust the aperture of the photographing device and detects whether the response value of the clarity evaluation function changes after the adjustment of the aperture. IN response to detecting that the response value of the clarity evaluation function changes, S505 is executed.

At S505, clarity information of the key point is determined as not satisfying a clarity condition, and then S506 is executed.

In some embodiments, after the photographing processing device detects that the response value of the clarity evaluation function changes after the adjustment of the aperture, the photographing processing device determines that the clarity information of the key point does not satisfy the clarity condition, and then executes S506.

At S506, the key point where the response value of the clarity evaluation function changes is determined as the candidate key point for adjustment.

In some embodiments, after the photographing processing device determines that the clarity information of the key point does not satisfy the clarity condition, the photographing processing device determines the key point where the response value of the clarity evaluation function changes as the candidate key point for adjustment. In some embodiments, the candidate key point for adjustment is the key point of the image where the response value of the clarity evaluation function changes.

Referring to FIG. 3B, the photographing processing device determines that the clarity information of the key point does not satisfy the clarity condition. In response to detecting that the response value of the clarity evaluation function for the key point of the right-eye image region 311 in the human face image 31 changes, the key point of the right-eye image region 311 is determined as the candidate key point for adjustment.

At S507, the aperture of the photographing device is adjusted according to the response value of the clarity evaluation function for the candidate key point for adjustment.

In some embodiments, the photographing processing device may adjust the aperture of the photographing device according to the response value of the clarity evaluation function for the candidate key point for adjustment.

In some embodiments, the photographing processing device may reduce the size of the aperture of the photographing device according to the response value of the clarity evaluation function for the candidate key point for adjustment. After it is detected that the response value of the clarity evaluation function for the candidate key point for adjustment does not change after the size of the aperture of the photographing device is reduced, further adjustment of the aperture is no longer needed and the size of the aperture before the reduction is determined to be the desired size of the aperture. In some embodiments, the response value of the clarity evaluation function increases as the size of the aperture decreases.

For example, when the photographing processing device detects that the response value of the clarity evaluation function for the candidate key point for adjustment increases after the size of the aperture of the photographing device is reduced, the photographing processing device continues to reduce the size of the aperture of the photographing device. When the photographing processing device detects that the response value of the clarity evaluation function for the candidate key point for adjustment does not change after the size of the aperture of the photographing device is reduced, the photographing processing device stops further adjustment of the aperture and the size of the aperture before the reduction is determined to be the desired size of the aperture.

In some embodiments, when the photographing processing device detects that the response value of the clarity evaluation function for the candidate key point for adjustment changes after the size of the aperture of the photographing device is adjusted, the photographing processing device map determine that the clarity information of the candidate key point for adjustment does not satisfy the clarity condition and hence continues to adjust the aperture until the response value of the clarity evaluation function for the candidate key point for adjustment on longer changes.

At S508, the clarity information of the key point is determined as satisfying the clarity condition.

In some embodiments, when the photographing processing device detects that the response value of the clarity evaluation function does not change, the photographing processing device may determine that the clarity information of the key point satisfies the clarity information and the photographing device photographs images with the adjusted aperture.

In some embodiments, the photographing processing device may receive the image of the target object photographed by the photographing device, obtain the key point of the image, and determine the response value of the clarity evaluation function for the key point. When the photographing processing device detects that the response value of the clarity evaluation changes after the photographing parameter of the photographing device is adjusted, the photographing processing device determines that the clarity information of the key point does not satisfy the clarity condition. Further, the key point where the response value of the clarity evaluation function changes is determined as the candidate key point for adjustment, and the aperture of the photographing device is adjusted according to the response value of the clarity evaluation function for the candidate key point for adjustment. Through the adjustment of the aperture of the photographing device, the clarity of the image is adjusted and improved.

FIG. 6 is a flow chart of a photographing processing method according to another example embodiment of the present disclosure. The method may be executed by the above-described photographing processing device. The method shown in FIG. 6 is similar to the method shown in FIG. 5. The difference is a detail description of adjusting the brightness of the photographing image. As shown in FIG. 6, the method includes the following steps.

At S601, an image of a target object photographed by a photographing device is received.

In some embodiments, the photographing processing device may receive the image of the target object photographed by the photographing device. The previous description can be referred to for the specific implementation, which will not be repeated herein.

At S602, a key point of the image is obtained.

In some embodiments, the photographing processing device may obtain the key point of the image. The previous description can be referred to for the specific implementation, which will not be repeated herein.

At S603, a response value of a clarity evaluation function for the key point is determined.

In some embodiments, the photographing processing device may determine the response value of the clarity evaluation function for the key point. The previous description can be referred to for the specific implementation, which will not be repeated herein.

At S604, in response to the response value of the clarity evaluation function not changing after the aperture of the photographing device is adjusted, a photographing mode operation is obtained, and the image is divided into a plurality of sub-image regions according to the key point.

In some embodiments, when the photographing processing device detects that the response value of the clarity evaluation function does not change after the aperture of the photographing device is adjusted, the photographing processing device may obtain the photographing mode operation, and may divide the image into the plurality of different sub-image regions according to the key point.

For example, assuming that the image is the human face image. When the photographing processing device divides the image according to the key point, the photographing processing device may divide the human face image according to the key point of the human face image into a plurality of different image regions, such as a left face, a right face, a forehead, a chin, a left eye, a right eye, a nose, and the like.

In some embodiments, dividing the image according to the key point may be performed by a region division operation of the photographing processing device. In some embodiments, the division according to the key point may be pre-configured. The photographing processing device performs a key point division according to the pre-configured division according to the key point.

In some embodiments, when the photographing processing device divides the image according to the key point, the photographing processing device determines the position information (u, v) of all the key points and the corresponding sequence numbers of all the key points, and connects the corresponding sequence numbers of all the key points to form a plurality of closed shapes, i.e., the sub-image regions.

At S605, a shutter speed and/or a sensitivity of the photographing device are adjusted according to the photographing mode.

In some embodiments, after the photographing processing device divides the image into the plurality of sub-image regions, the photographing processing device adjusts the shutter speed and/or the sensitivity of the photographing device according to the photographing mode.

In some embodiments, the photographing processing device may obtain pixels in each sub-image region and determine a response value of a brightness evaluation function for each sub-image region.

In some embodiments, the photographing processing device may adjust the shutter speed and/or the sensitivity for the key point in each sub-image region according to the response value of the brightness evaluation function.

In some embodiments, when the photographing processing device adjusts the shutter speed and the sensitivity of the key point in each sub-image region, the photographing processing device may obtain the aperture size information after the aperture of the photographing device is adjusted, and may adjust the shutter speed and the sensitivity of the key point in each sub-image region according to the aperture size information and the response value of the brightness evaluation function for the key point in each sub-image region.

In some embodiments, the photographing processing device may assign different weights for different sub-image regions obtained by the division. The value of each weight determines the brightness of the corresponding sub-image region relative to the image. In some embodiments, the weights may be configured by a user or may be automatically selected by the photographed device according to the pre-configured weights.

In some embodiments, the photographing processing device may apply the aperture size after the adjustment in the brightness evaluation function, and the photographing device may automatically select the shutter speed and the sensitivity to adjust the brightness.

In some embodiments, the photographing mode includes a self-defined mode. When the photographing processing device adjusts the shutter speed and/or the sensitivity of the photographing device according to the photographing mode, the photographing processing device obtains a self-defined brightness operation for each sub-image region according to the self-defined mode, obtains the weight in the brightness evaluation function for each sub-image region and the response value of the brightness evaluation function, and adjusts the shutter speed and/or the sensitivity of the photographing device according to the weight in the brightness evaluation function for each sub-image region and response value of the brightness evaluation function. In some embodiments, the weight in the brightness evaluation function for each sub-image region may be configured by the user, which is not limited in the present disclosure.

In some embodiments, the photographing mode includes a non-self-defined mode. When the photographing processing device adjusts the shutter speed and/or the sensitivity of the photographing device according to the photographing mode, the photographing processing device adjusts the shutter speed and/or the sensitivity of the photographing device according to the weight in the brightness evaluation function for each sub-image region in the non-self-defined mode and response value of the brightness evaluation function. In some embodiments, the non-self-defined mode may be configured with different weights. For example, in a non-self-defined mode built in the photographing device, such as “soft light,” “Japanese-style,” or “Blues,” different weights in the brightness evaluation function can be assigned for different sub-image regions. In some embodiments, one or more non-self-defined modes can be provided, which is not limited in the present disclosure.

In some embodiments, the photographing processing device may obtain the key point of the image. When the photographing processing device detects that the response value of the clarity evaluation function for the key point does not change after the aperture of the photographing device is adjusted, the photographing processing device divides the image into the plurality of sub-image regions according to the key point, determines the response value of the brightness evaluation function for the key point in each sub-image region, adjusts the shutter speed and/or the sensitivity of the photographing device for the key point in each sub-image region according to the response value of the brightness evaluation function, and outputs the image of the target object photographed by the photographing device after the shutter speed and/or the sensitivity are adjusted. Adjusting the brightness of the key point after the aperture adjustment further improves the quality of the image.

FIG. 7 is a structural diagram of a photographing processing device according to an example embodiment of the present disclosure. As shown in FIG. 7, the photographing processing device includes a memory 701, a processor 702, and a data interface 703.

The memory 701 may be a volatile memory, a non-volatile memory, or a combination thereof. The processor 702 may be a central processing unit (CPU), an application-specific integrated circuit (ASIC), a programmable logic device (PLD), a complex programmable logic device (CPLD), a field programmable gate array (FPGA), or a combination thereof.

In some embodiments, the memory 701 is configured to store program instructions. The processor 702 invokes and executes the program instructions to: receive an image of a target object photographed by a photographing device, obtain a key point of the image, determining whether clarity information of the key point satisfies a clarity condition, and adjust a photographing parameter of the photographing device in response to the clarity information of the key point not satisfying the clarity condition.

In some embodiments, when obtaining the key point of the image, the processor 702 invokes and executes the program instructions to: determine a target image region in the image, and obtain the key point of the target image region.

In some embodiments, when determining the target image region in the image, the processor 702 invokes and executes the program instructions to: determine the target image region in the image according to an image region selection operation.

In some embodiments, the photographing parameter includes at least one of aperture, shutter speed, or sensitivity.

In some embodiments, when determining whether the clarity information of the key point satisfies the clarity condition, the processor 702 invokes and executes the program instructions to: determine a response value of a clarity evaluation function for the key point, detect whether the response value of the clarity evaluation function changes after the photographing parameter of the photographing device is adjusted, determine that the clarity information of the key point satisfies the clarity condition in response to the response value of the clarity evaluation function not changing after the photographing parameter of the photographing device is adjusted, and determine that the clarity information of the key point does not satisfy the clarity condition in response to the response value of the clarity evaluation function changing after the photographing parameter of the photographing device is adjusted.

In some embodiments, when adjusting the photographing parameter of the photographing device, the processor 702 invokes and executes the program instructions to: adjust the photographing parameter of the photographing device in response to the clarity information of the key point not satisfying the clarity condition.

In some embodiments, when adjusting the photographing parameter of the photographing device, the processor 702 invokes and executes the program instructions to: determine the key point where the response value of the clarity evaluation function changes as a candidate key point for adjustment, and adjust the photographing parameter of the photographing device according to the response value of the clarity evaluation function for the candidate key point for adjustment.

In some embodiments, after determining that the clarity information of the key point satisfies the clarity condition, the processor 702 invokes and executes the program instructions to: photograph another image with the photographing parameter.

In some embodiments, the photographing parameter includes the aperture, and when adjusting the photographing parameter of the photographing device, the processor 702 invokes and executes the program instructions to: reduce a size of the aperture.

In some embodiments, the photographing parameter also includes the shutter speed and/or the sensitivity, and when photographing the image with the photographing parameter, the processor 702 invokes and executes the program instructions to: obtain a photographing mode, and adjust the shutter speed and/or the sensitivity of the photographing device according to the photographing mode.

In some embodiments, before adjusting the shutter speed and/or the sensitivity of the photographing device according to the photographing mode, the processor 702 invokes and executes the program instructions to: divide the image into a plurality of sub-image regions according to the key point.

In some embodiments, the photographing mode includes a self-defined mode, and when adjusting the shutter speed and/or the sensitivity of the photographing device according to the photographing mode, the processor 702 invokes and executes the program instructions to: obtain a self-defined brightness operation for each sub-image region according to the self-defined mode, obtain a weight in the brightness evaluation function for each sub-image region and the response value of the brightness evaluation function, and adjust the shutter speed and/or the sensitivity of the photographing device according to the weight in the brightness evaluation function for each sub-image region and the response value of the brightness evaluation function.

In some embodiments, the photographing mode includes a non-self-defined mode, and when adjusting the shutter speed and/or the sensitivity of the photographing device according to the photographing mode, the processor 702 invokes and executes the program instructions to: adjust the shutter speed and/or the sensitivity of the photographing device according to the weight in the brightness evaluation function for each sub-image region in the non-self-defined mode and the response value of the brightness evaluation function.

In some embodiments, the image includes a human face image.

In some embodiments, the photographing processing device receives the image of the target object photographed by the photographing device, obtains the key point of the image, determines whether the clarity information of the key point satisfies the clarity condition, and adjusts the photographing parameter of the photographing device in response to the clarity information of the key point not satisfying the clarity condition. Through adjusting the photographing parameter of the photographing device, a success rate of photographing the image by the photographing device is improved, and the quality and clarity of the image is improved.

The present disclosure also provides a computer-readable storage medium. The computer-readable storage medium stores a computer program. When being executed by a processor, the computer program implements the photographing processing method shown in FIG. 2, FIG. 4, or FIG. 6, or the photographing processing device shown in FIG. 7. The detail description is omitted herein.

The computer-readable storage medium may be an internal storage unit of the device described in the embodiments of the present disclosure. For example, the computer-readable storage medium may be a hard disk or a memory of the device. The computer-readable storage medium may also be an external storage device of the device described in the embodiments of the present disclosure. For example, the computer-readable storage medium may be a plug-in hard disk, a smart media card (SMC), a secure digital card (SD), or a flash card, etc. In some embodiments, the computer-readable storage medium may also include both the internal storage unit and the external storage device. The computer-readable storage medium is configured to store the computer program, and another program and data required by the device. The computer-readable storage medium may also be configured to temporarily store data that has been outputted or will be outputted.

A person of ordinary skill in the art can understand that some or all of the processes in the above-described embodiments can be implemented by instructing relevant hardware through the computer program. The computer program may be stored in the computer-readable storage medium. When being executed, the computer program implements the processes in the above-described embodiments. The computer-readable storage medium may be a magnetic disk, an optical disk, a read-only memory (ROM), or a random-access memory (RAM), etc.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A photographing processing method comprising:
receiving an image of a target object photographed by a photographing device;
obtaining a key point of the image;
determining whether clarity information of the key point satisfies a clarity condition; and
adjusting a photographing parameter of the photographing device in response to the clarity information of the key point not satisfying the clarity condition.

2. The method according to claim 1, wherein obtaining the key point of the image includes:
determining a target image region in the image; and
obtaining the key point of the target image region.

3. The method according to claim 2, wherein determining the target image region in the image includes:
determining the target image region in the image according an image region selection operation.

4. The method according to claim 1, wherein:
the photographing parameter includes at least one of aperture, shutter speed, or sensitivity.

5. The method according to claim 1, wherein determining whether the clarity information of the key point satisfies the clarity condition includes:
determining a response value of a clarity evaluation function for the key point;
detecting whether the response value of the clarity evaluation function changes after the photographing parameter of the photographing device is adjusted;
determining that the clarity information of the key point satisfies the clarity condition in response to the response value of the clarity evaluation function not changing after the photographing parameter of the photographing device is adjusted; and
determining that the clarity information of the key point does not satisfy the clarity condition in response to the response value of the clarity evaluation function changing after the photographing parameter of the photographing device is adjusted.

6. The method according to claim 5, wherein adjusting the photographing parameter of the photographing device in response to the clarity information of the key point not satisfying the clarity condition includes:
performing an adjustment operation on the photographing parameter of the photographing device in response to the clarity information of the key point not satisfying the clarity condition.

7. The method according to claim 6, wherein adjusting the photographing parameter of the photographing device includes:
determining the key point as a candidate key point for adjustment in response to detecting that the response value of the clarity evaluation function for the key point changes; and
adjusting the photographing parameter of the photographing device according to the response value of the clarity evaluation function for the candidate key point.

8. The method according to claim 5, further comprising, after determining that the clarity information of the key point satisfies the clarity condition:
photographing an additional image with the photographing parameter.

9. The method according to claim 8, wherein:
the photographing parameter includes at least one of a shutter speed or a sensitivity; and
the method further comprising, before photographing the additional image with the photographing parameter:
obtaining a photographing mode; and
adjusting the at least one of the shutter speed or the sensitivity according to the photographing mode.

10. The method according to claim 9, further comprising, before adjusting the at least one of the shutter speed or the sensitivity:
dividing the image into a plurality of sub-image regions according to the key point.

11. A photographing processing device comprising:
a memory storing program instructions; and
a processor configured to execute the program instructions to:
receive an image of a target object photographed by a photographing device;
obtain a key point of the image;
determine whether clarity information of the key point satisfies a clarity condition; and
adjust a photographing parameter of the photographing device in response to the clarity information of the key point not satisfying the clarity condition.

12. The device according to claim 11, wherein the processor is further configured to execute the program instructions to:
determine a target image region in the image; and
obtain the key point of the target image region.

13. The device according to claim 12, wherein the processor is further configured to execute the program instructions to:
determine the target image region in the image according an image region selection operation.

14. The device according to claim 11, wherein:
the photographing parameter includes at least one of aperture, shutter speed, or sensitivity.

15. The device according to claim 12, wherein the processor is further configured to execute the program instructions to:
determine a response value of a clarity evaluation function for the key point;
detect whether the response value of the clarity evaluation function changes after the photographing parameter of the photographing device is adjusted;
determine that the clarity information of the key point satisfies the clarity condition in response to the response value of the clarity evaluation function not changing after the photographing parameter of the photographing device is adjusted; and
determine that the clarity information of the key point does not satisfy the clarity condition in response to the response value of the clarity evaluation function changing after the photographing parameter of the photographing device is adjusted.

16. The device according to claim 15, wherein the processor is further configured to execute the program instructions to:
perform an adjustment operation on the photographing parameter of the photographing device in response to the clarity information of the key point not satisfying the clarity condition.

17. The device according to claim 16, wherein the processor is further configured to execute the program instructions to:
determine the key point as a candidate key point for adjustment in response to detecting that the response value of the clarity evaluation function for the key point changes; and
adjust the photographing parameter of the photographing device according to the response value of the clarity evaluation function for the candidate key point.

18. The device according to claim 15, wherein the processor is further configured to execute the program instructions to, after determining that the clarity information of the key point satisfies the clarity condition:
photograph an additional image with the photographing parameter.

19. The device according to claim 18, wherein:
the photographing parameter includes at least one of a shutter speed or sensitivity; and
the processor is further configured to execute the program instructions to, before photographing the additional image with the photographing parameter:
obtain a photographing mode; and
adjust the at least one of the shutter speed or the sensitivity according to the photographing mode.

20. The device according to claim 19, wherein the processor is further configured to execute the program instructions to:
before adjusting the at least one of the shutter speed or the sensitivity according to the photographing mode, divide the image into a plurality of sub-image regions according to the key point.
